(19) United States
(12) Patent Application Publication
(10) Pub. No.: US 2006/0179165 A1
(43) Pub. Date: Aug. 10, 2006

(54) Multipurpose charging system with transmission function

(76) Inventor: Ming-Chun Chen, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/046,821

(22) Filed: Feb. 1, 2005

(51) Int. Cl. G06F 3/00

(52) U.S. Cl. 710/5

(57) ABSTRACT

A multipurpose charging system with a transmission function is capable of solving the power consumption problem of a handheld device when the handheld device is connected to a peripheral device. The multipurpose charging system has a handheld device, a transformer device, and a USB line. The handheld device has a built-in USB host chip and a USB socket, and electrically connected to the transformer device by the USB line. The transformer device further has an Ethernet interface and a USB port. The multipurpose charging system can charge the handheld device, supply electric power for a peripheral device connected to the USB port, transmit data, and use an Ethernet by the transformer device at the same time.

### BACKGROUND OF THE INVENTION

1. Field of the Invention

The present invention relates to a multipurpose charging system with a transmission function, and more particularly, to a multipurpose charging device provides a handheld device with electricity, supplying electric power for a peripheral device connecting to a USB port, and transmitting signals and connecting to an Ethernet at the same time.

2. Description of the Related Art

Nowadays, compact and convenient handheld devices, such as mobile phones and PDAs, have already played important roles in our jobs and daily life. Handheld devices are not only small but also easy to carry, and provide a variety of functions that make life more convenient and enjoyable. For example, wireless communications, rapid information inquiry, and data input and output all are of great use and convenience to people.

The power consumption problem of handheld devices is always an important consideration for system design. Some peripheral devices are mature technology, such as, for example, peripheral devices using the USB interface like the Iomega Clik! Drive and Thumb Drive. If a handheld device with a built-in the USB host chip is immediately transmitted to the peripheral device, the result makes the handheld device consume more the power. The handheld device must therefore transmit data with the peripheral device or connecting network by the personal computer or notebook.

If the handheld is connected to a peripheral device for transmitting data by the USB host chip electrically coupling with the USB socket, an electric device is necessary for a normal and stable power supply.

FIG. 1 illustrates the prior art, and is a diagram showing the charging system of handheld device having a USB host chip. The system includes a handheld device 1, a peripheral device 4, a USB line 3 and a transformer device 2. The handheld device 1 has a USB host chip 10, a USB socket 12 and a battery 14. The USB host chip 10 is electrically coupled to the USB socket 12. The peripheral device 4 has a USB port 40, and the USB line 3 electrically connects between the USB socket 12 and USB port 40 for the handheld device 1 supplying power to the peripheral device 4 with data transmission. The transformer device 2 has a voltage converter 20 and a charging plug 22. The charging plug 22 is electrically connected to the voltage converter 20, and the voltage converter 20 supplies power to the handheld device 1 for charging the battery 14. The handheld device 1 is stably supplied power while transmitting data with the peripheral device 4.

### SUMMARY OF THE INVENTION

An object of the present invention is to provide a multipurpose charging system with transmission function, including a handheld device, a transformer device and a USB line. The handheld device has a USB host chip, a USB socket and a battery. The USB host chip electrically couples to the USB socket. The transformer device has a charging plug, a voltage converter, a USB port, an USB Ethernet chip, an Ethernet interface and a multiplexer. The charging plug is electrically connected to the voltage converter, and the voltage converter is electrically connected to the multiplexer, the USB port and the USB Ethernet chip with a power supply. The multiplexer has at least two downlink ports and a uplink. One of the downlink ports is electrically connected to the USB Ethernet chip; the others are electrically connect to the connect port. The USB line is electrically connected between the transformer device and the USB socket for charging the handheld device by the transformer device; moreover, the USB line is also electrically coupled to the uplink while transmitting data.

### BRIEF DESCRIPTION OF THE DRAWINGS

The foregoing aspect aspects and many of the attendant advantage of this invention will be more readily appreciated as the same becomes better understood by reference to the following detailed description, when taken in conjunction with the accompanying drawings, wherein:

FIG. 1 is a diagram showing a prior charging system of handheld device having USB host chip according to the present invention;

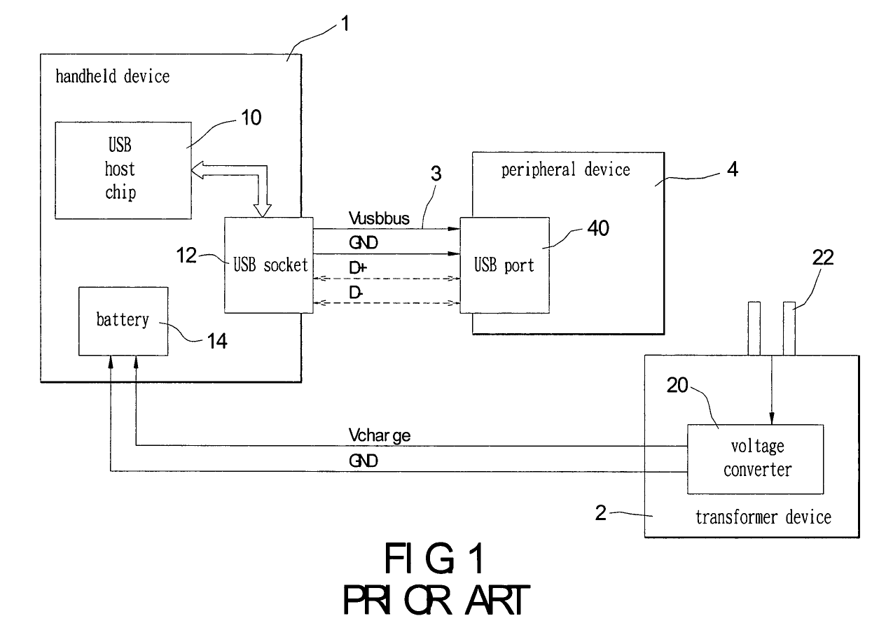

FIG. 2 is a diagram showing a first embodiment of a multipurpose charging system with a transmission function according to the present invention;

FIG. 3 is diagram showing a second embodiment of a multipurpose charging system with a transmission function according to the present invention; and

FIG. 4 is a diagram showing a third embodiment of a multipurpose charging system with a transmission function according to the present invention.

### DETAILED DESCRIPTION OF PREFERRED EMBODIMENTS

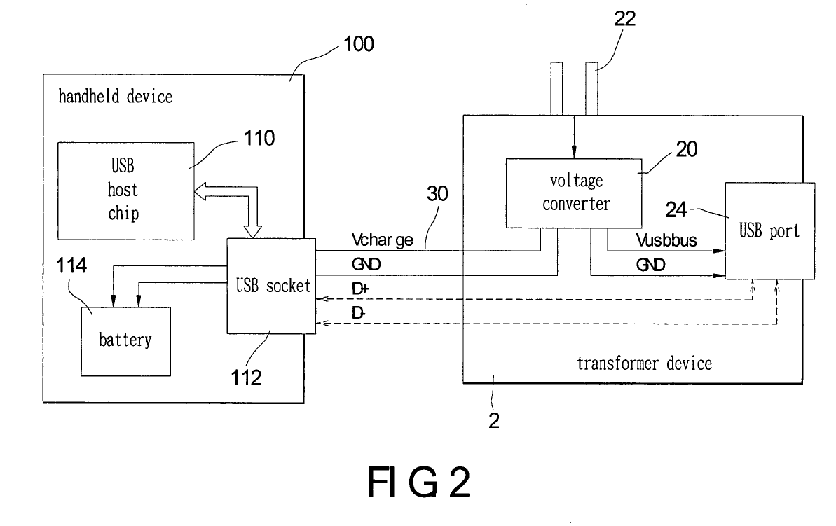

Referring to FIG. 2, a diagram showing a first embodiment of a multipurpose charging system with a transmission function of the present invention is illustrated. A handheld device 100 has a USB host chip 110 and a USB socket 112. The USB host chip 110 is electrically coupled to the USB socket 112, and the handheld further includes a battery 114 electrically connected to the USB socket 112 for charging itself. A transformer device 2 has a voltage converter 20, a charging plug 22 and a USB port 24. The charging plug 22 is electrically connected to the voltage converter 20, and the voltage converter 20 electrically connects to the USB port 24 for supplying power to a peripheral device that connects to the USB port 24. A USB line 30 is electrically connecting between the transformer device 2 and the USB socket 112 for charging the handheld device 100 by the USB socket 112, and the USB line 30 is also electrically connected to the USB port 24 to make the handheld device 100 transmit a signal to a peripheral device connected to the USB port 24.

The charging plug 22 is then electrically connected to a main power, and the transformer device 2 charges the handheld device 100 by the USB line 30. At the same time the transformer device 2 supply power to the peripheral device that connects to the USB port 24; moreover, the handheld device 100 transmits a signal to the peripheral device.

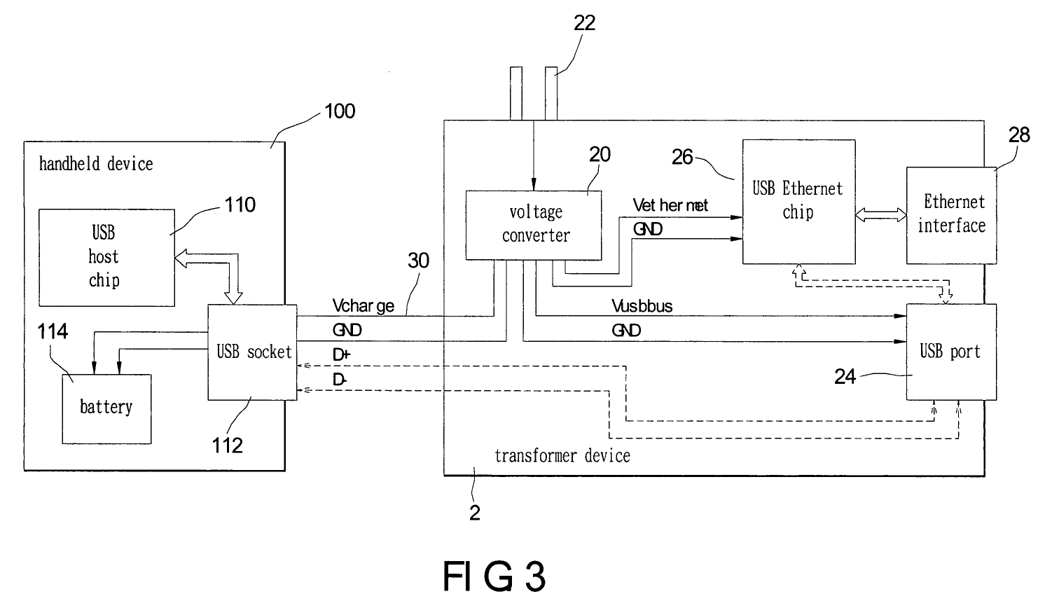

FIG. 3 is diagram showing a second embodiment of a multipurpose charging system with a transmission function of the present invention. The transformer device 2 further has a USB Ethernet chip 26 and an Ethernet interface 28. The USB Ethernet chip 26 is electrically connected to the voltage converter 20 and electrically coupled to the USB port 24 with the Ethernet interface 28.

The handheld device 100 is electrically connected to the transformer device 2 by the USB line 30, which is charged at the same time and selects connecting a network by the Ethernet interface 28 or transmitting data with a peripheral device that is connected to the USB port 24.

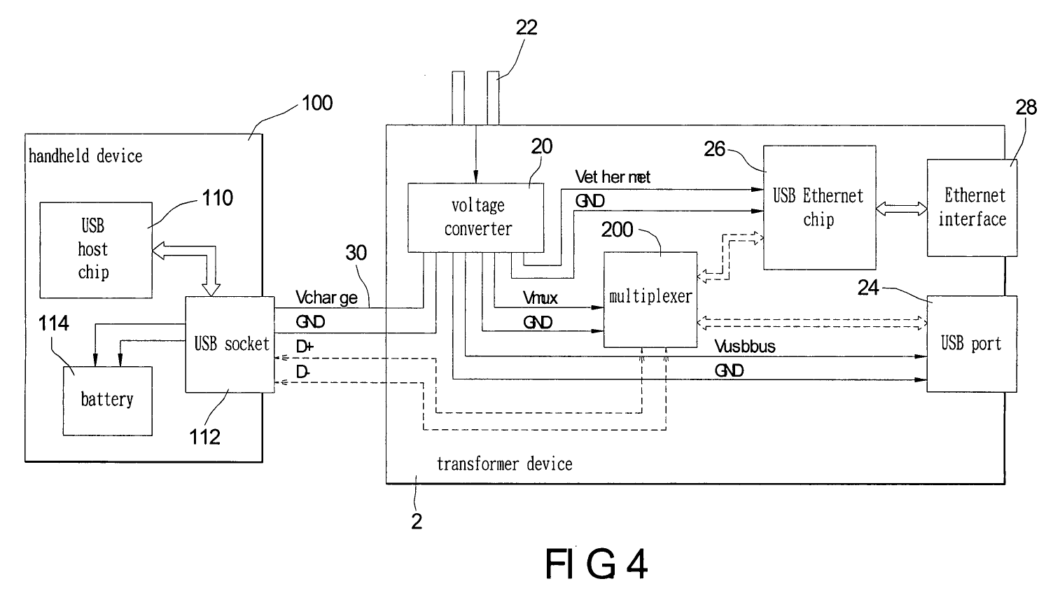

FIG. 4 is a diagram showing a third embodiment of a multipurpose charging system with a transmission function of the present invention. The transformer device 2 has a hub controller (or multiplexer) 200. The multiplexer 200 has at least two downlink ports and an uplink port. The voltage converter 20 is electrically connected to the multiplexer 200 with supplying power, one of the downlink ports is electrically connected to the USB Ethernet chip 26, the others electrically connect to the USB port 24, and the uplink electrically couples the USB line 30.

When the multiplexer 200 is operating, one of the downlink ports is selected by the uplink for transmitting data to the handheld device 100. The handheld device 100 thus synchronously transmits data by the Ethernet interface 28 connecting to a network and the peripheral device inserted into the USB port 24.

In conclusion, the handheld device is electrically connected to the transformer device by the USB line according to the present invention to provide the multiplexer charging system with a transmission function, and has the following characteristics:

1. The transformer device can charge the handheld device while transmitting data at the same time;

2. The transformer device can supply power to the peripheral device while transmitting data at the same time; and

3. Use of the multiplexer allows the handheld device to transmit synchronously data by the Ethernet interface connecting a network and the peripheral device inserted into the USB port.

To sum up the functions of the present invention, other buses having a transmission function are also used, with the exception of a USB port or a USB socket.

What is claimed is:

1. A multipurpose charging system with a transmission function, comprising:
a handheld device having a USB host chip and a USB socket, the USB host chip being electrically connected to the USB socket, and the handheld device being charged through the USB socket;
a transformer device having a charging plug, a voltage converter, and a USB port, the charging plug being electrically connected to the voltage converter, and the voltage converter being electrically connected to the USB port for supplying power to a peripheral device connected to the USB port; and
a USB line electrically connected the transformer device and the USB socket so that the transformer device to charge the handheld device, wherein the USB line is electrically connected to the USB port to transmit a signal between the handheld device and the peripheral device.

2. The multipurpose charging system of claim 1, wherein the handheld device includes a battery electrically connected to the USB socket to charge.

3. The multipurpose charging system of claim 1, wherein the voltage converter is an AC to DC power converter.

4. The multipurpose charging system of claim 1, wherein the voltage converter converts an input voltage into at least one DC output voltage.

5. The multipurpose charging system of claim 1, wherein the transformer device includes a USB Ethernet chip and an Ethernet interface, the USB Ethernet chip is electrically connected to the voltage converter, and the USB Ethernet chip electrically couples the USB port with the Ethernet interface.

6. A multipurpose charging device with a transmission function, comprising:
a charging plug;
a voltage converter outputting a first DC voltage by converting an input voltage of the charging plug;
a first port electrically connected to the voltage converter for supplying a first voltage to a first device connected to the first port; and
a signal line electrically connected to the first port, wherein the signal line transmits a signal between a second device and the first device.

7. The multipurpose charging device of claim 6, wherein the first port is a USB port.

8. The multipurpose charging device of claim 6, wherein the voltage converter supplies a second voltage to charge the second device.

9. The multipurpose charging device of claim 6, further comprising a second port electrically coupled to the signal line.

10. The multipurpose charging device of claim 6, further comprising an Ethernet chip and an Ethernet interface, wherein the Ethernet chip is electrically connected to the voltage converter and the Ethernet chip is electrically coupled to the first port and the Ethernet interface.

11. A multipurpose charging system with a transmission function, comprising:
a handheld device having a connection socket, the handheld device being charged through the connection socket;
a transformer device having a charging plug, a voltage converter, an Ethernet chip, and an Ethernet interface, wherein the charging plug is electrically connected to the voltage converter, the voltage converter is electrically connected to the Ethernet chip, and the Ethernet chip is electrically coupled to the Ethernet interface; and
a transmission line electrically connected the transformer device with the connection socket, and the transmission line electrically coupled to the Ethernet chip.

12. The multipurpose charging system of claim 11, wherein the voltage converter is electrically connected to the transmission line.

13. The multipurpose charging system of claim 11, wherein the handheld device includes a battery that is electrically connected to the connection socket for charging.

14. The multipurpose charging system of claim 11, wherein the voltage converter converts an input voltage into at least one output voltage to charge the handheld device and the Ethernet chip respectively.

15. The multipurpose charging system of claim 11, wherein the transformer device further includes a connection port, the connection port is electrically coupled to the transmission line to transmit a signal between the handheld device and a peripheral device connected to the connection port.

16. The multipurpose charging system of claim 15, wherein the transformer device includes a multiplexer having at least two downlink ports and an uplink port, wherein the downlink ports are electrically connected to the Ethernet chip and the connection port respectively, and the uplink port is electrically coupled to the transmission line.

17. The multipurpose charging system of claim 15, wherein the connection port is electrically connected to the voltage converter to supply power to the peripheral device.

18. The multipurpose charging system of claim 15, wherein the connection port is a USB port.

19. The multipurpose charging system of claim 11, wherein the connection socket is a USB socket.

20. The multipurpose charging system of claim 19, wherein the connection socket is electrically coupled to a USB host chip.
